(19) United States
(12) Patent Application Publication
(10) Pub. No.: US 2013/0239774 A1
(43) Pub. Date: Sep. 19, 2013

(54) Mouthpiece for Woodwind Instrument with Improved Tenon

(71) Applicant: BARI WOODWIND SUPPLIES, LLC, Sarasota, FL (US)

(72) Inventors: Gary Spears, Palmetto, FL (US); John V. Cavanaugh, Sarasota, FL (US); Ellen J. Cavanaugh, Sarasota, FL (US); V. James Cavanaugh, Sarasota, FL (US); Ronald Van Ostenbridge, Bradenton, FL (US)

(73) Assignee: Bari Woodwind Supplies, LLC, Sarasota, FL (US)

(21) Appl. No.: 13/800,161

(22) Filed: Mar. 13, 2013

Related U.S. Application Data
(60) Provisional application No. 61/611,945, filed on Mar. 16, 2012.

(51) Int. Cl. G10D 9/02

(52) U.S. Cl. CPC G10D 9/02
USPC 84/380 R

(57) ABSTRACT

A mouthpiece for a woodwind musical instrument includes a generally cylindrical body between a front end and a rear end and an elongated airflow passage extending along a path between the front end and the rear end. A window defines an opening of the passage generally adjacent the front end and the body includes a table upon which a reed may be mounted. The rear end has an enlarged generally cylindrical tenon section integrally formed therewith and the tenon section is larger than the cylindrical body.

### CROSS-REFERENCE TOR RELATED APPLICATIONS

This patent application claims the benefit of U.S. Provisional Patent Application No. 61/611,945, filed Mar. 16, 2012, which is incorporated herein by reference.

### TECHNICAL FIELD

This disclosure relates generally to a musical instrument and, more particularly, to a mouthpiece of a single reed woodwind instrument.

### BACKGROUND

Single reed woodwind instruments generally include a generally cylindrical, hollow mouthpiece upon which a reed is mounted. The reed typically has a flexible tapered, thin end that extends over an opening or window of the mouthpiece. Sound is produced within the body of the instrument by a vibrating column of air that is created by rapid movement of the reed. In essence, the vibrating reed interacts with the mouthpiece to act as a reed valve to periodically interrupt the flow of air from a musician's mouth.

The reed is held in place against a lower surface or table of the mouthpiece by a clamping structure known as a ligature. How the reed is clamped in place may significantly affect or impact the performance of the musical instrument. Accordingly, many different types of ligatures have been proposed.

The tone and performance characteristics of the musical instrument may also be influenced by the physical arrangement and geometry of various aspects of the mouthpiece. For example, the configuration of the interior surfaces of the mouthpiece adjacent the window such as the sidewalls and the upper wall or baffle connecting the sidewalls have a significant impact on the performance of the mouthpiece. A mouthpiece in which the baffle is generally close to the window is considered to be brighter, lighter or crisper while a baffle that is further from the window may be considered darker, heavier or fuller. Depending upon the style of the musician and the pieces being performed, one type of mouthpiece may be desirable over another.

In addition, the physical arrangement and geometry of the mouthpiece may also affect or impact how the mouthpiece is perceived by the musician. The configuration of the mouthpiece may impact the back pressure of the mouthpiece as well as the ease with which the musician may play certain notes. For example, brighter mouthpieces generally have less back pressure while darker mouthpieces generally have more back pressure. In addition, it may be more difficult to reach low notes with a brighter mouthpiece while higher notes may be more challenging with a darker mouthpiece.

As a result, choosing particular characteristics for a mouthpiece often results in trade-offs relative to other characteristics. It would be desirable for a mouthpiece to include certain desirable characteristics of each type of mouthpiece while minimizing the characteristics that are less desirable.

the foregoing background discussion is intended solely to aid the reader. It is not intended to limit the innovations described herein nor to limit or expand the prior art discussed. Thus the foregoing discussion should not be taken to indicate that any particular element of a prior system us unsuitable for use with the innovations described herein, nor is it intended to indicate any element, including solving the motivating problem, to be essential in implementing the innovations described herein. The implementations and application of the innovations described herein are defined by the appended claims.

### SUMMARY

In one aspect, a mouthpiece for a woodwind musical instrument includes a generally tapered front end, a rear end configured for mounting to the musical instrument, a generally cylindrical body between the front end and the rear end, and an elongated airflow passage extending along a path between the front end and the rear end. A window defines an opening of the passage generally adjacent the front end and the body includes a table upon which a reed may be mounted such that a mounted reed extends generally across at least a portion of the window. The rear end has an enlarged generally cylindrical tenon section integrally formed therewith and the tenon section is larger than the cylindrical body.

In another aspect, a mouthpiece for a woodwind musical instrument includes a generally tapered front end, a rear end configured for mounting to the musical instrument, and a generally cylindrical body between the front end and the rear end. The generally cylindrical body has a first body diameter. An elongated central airflow passage extends along a path between the front end and the rear end and the central airflow passage has a forward section and an adjacent tone chamber. The body includes a table configured for mounting a reed thereon such that a mounted reed extends across at least a portion of the passage. The rear end has an enlarged generally cylindrical tenon section with the tenon section having a second tenon diameter larger than the first body diameter and the tenon section further including a plurality of openings therein.

In still another aspect, a mouthpiece assembly for a woodwind musical instrument includes a front end, a rear end configured for mounting to the musical instrument, and a generally cylindrical body between the front end and the rear rnd. The generally cylindrical body has a first body diameter. An elongated airflow passage extends along a path between the front end and the rear end and the airflow passage has a forward section and an adjacent tone chamber. The body includes a table configured for mounting a reed thereon such that a mounted reed extends across at least a portion of the airflow passage. The rear end has an enlarged tenon section with the tenon section having a generally cylindrical section and a tapered section extending between the cylindrical body and the generally cylindrical section of the tenon section. The generally cylindrical section of the tenon section has a second tenon diameter larger than the first body diameter.

### BRIEF DESCRIPTION OF THE DRAWINGS

FIG. 1 is a perspective view of a mouthpiece and ligature assembly according to the present disclosure;

FIG. 2 is a partially exploded perspective view of the mouthpiece and ligature assembly of FIG. 1 with the assembly rotated and upside down;

FIG. 3 is a perspective view of the mouthpiece depicted in FIG. 2;

FIG. 4 is a perspective view of the mouthpiece of FIG. 3 but rotated 180°;

FIG. 5 is a perspective view of a section taken generally along line 5-5 of FIG. 4;

FIG. 6 is a side view of the mouthpiece in FIG. 5;

FIG. 7 is a perspective view taken generally along line 7-7 of FIG. 5;

FIG. 8 is a side view of the mouthpiece of FIG. 7;

FIG. 9 is an enlarged, fragmented perspective view taken generally along line 9-9 of FIG. 4;

FIG. 10 is an enlarged, fragmented perspective view taken generally along line 10-10 of FIG. 4;

FIG. 11 is an end view of the mouthpiece showing still another alternate embodiment of the rear section;

FIG. 12 is a fragmented side view of a portion of FIG. 6 depicting an alternate embodiment of the rear section of the mouthpiece;

FIG. 13 is a fragmented side view similar to FIG. 12 but showing another alternate embodiment of the rear section of the mouthpiece;

FIG. 14 is an exploded perspective view of a ligature according to the present disclosure;

FIG. 15 is a section taken generally along line 15-15 of the mouthpiece and ligature assembly of FIG. 1;

FIG. 16 is a side view of the mouthpiece with a pair of ligatures positioned according to a first configuration;

FIG. 17 is a side view of the mouthpiece with the pair of ligatures positioned according to a second configuration;

FIG. 18 is a side view of the mouthpiece with a pair of ligatures positioned according to another configuration;

FIG. 19 is a side view of the mouthpiece with a pair of ligatures positioned according to still another configuration; and

FIG. 20 is a side view of the mouthpiece with the pair of ligatures positioned according to still another configuration.

### DETAILED DESCRIPTION

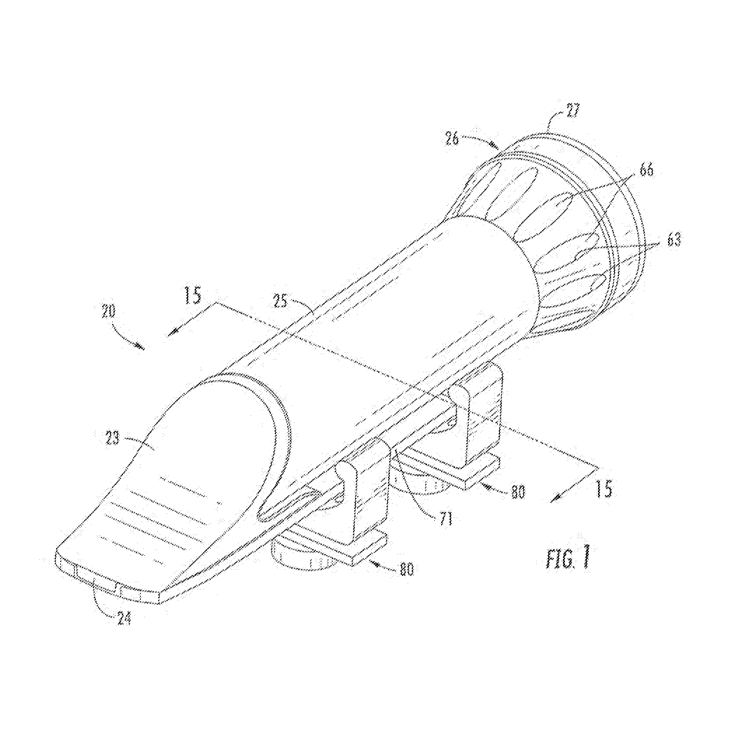

Referring to FIG. 1, a mouthpiece 20 for use with a single reed woodwind musical instrument, for example, a saxophone, is depicted. The mouthpiece 20 has a generally elongated, somewhat cylindrical shape with a central airflow passage 21 (FIG. 5) extending therethrough. The mouthpiece 20 may be formed of any suitable material including metal such as brass or stainless steel, plastic, rubber or a combination of materials. One or more ligatures 80 may be provided to engage and secure a reed 100 to a lower surface or table 71 of the mouthpiece 20.

Mouthpiece 20 has a tapered front end or beak 23 that ends rearwardly from the front tip 24 of the mouthpiece and is configured to be inserted into a musician's mouth when playing the musical instrument. A generally cylindrical main body or barrel 25 extends rearwardly from the tapered front end 23. The mouthpiece 20 may include an enlarged rear section or tenon 26 adjacent the rear end 27 of the mouthpiece.

Referring to FIGS. 5-8, airflow passage 21 has a forward section 30 extending rearwardly from the front tip 24 and generally within the tapered front end 23. A tone chamber 50 extends rearwardly from an exit or rear end 31 of forward section 30. A rear bore 55 extends rearwardly from the rear end 51 of the tone chamber 50. The bore 55 is configured to receive a neck portion of the musical instrument (not shown) therein.

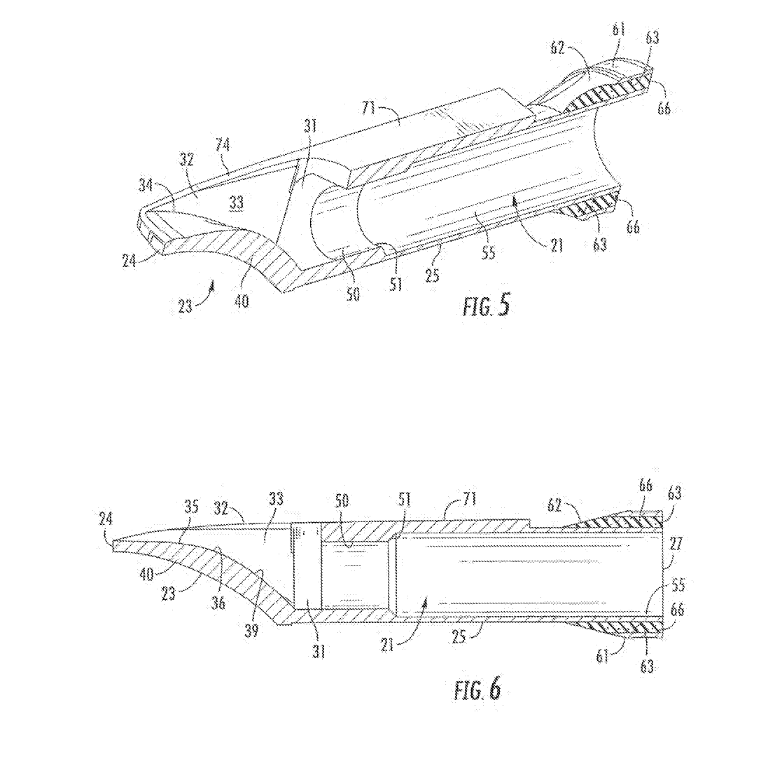

Forward section 30 of airflow passage 21 includes a generally planar entrance or window 32 that generally defines the front opening of the airflow passage 21. The forward section 30 of the airflow passage 21 is further defined by a pair of generally vertical, generally opposed sidewalls 33 that may be somewhat triangular in shape. The upper (lower as viewed in FIGS. 5-8) edges 34 of sidewalls 33 are connected by an upper surface or baffle 35. As best seen in the cross-section of FIG. 6, the forward section 30 generally expands from the front to rear of the section.

In many mouthpieces, the shape of the baffle is used to control or alter the tone and performance characteristics of the mouthpiece. A mouthpiece in which the baffle extends in a manner generally close to the window 32 is considered a high baffle and a mouthpiece in which the baffle is farther from the window is considered a low baffle. In general, a high baffle will produce a brighter tone while a low baffle will produce a darker tone. Many factors affect the brightness or darkness and other sound characteristics of a mouthpiece and the configuration or design of the baffle is just one factor.

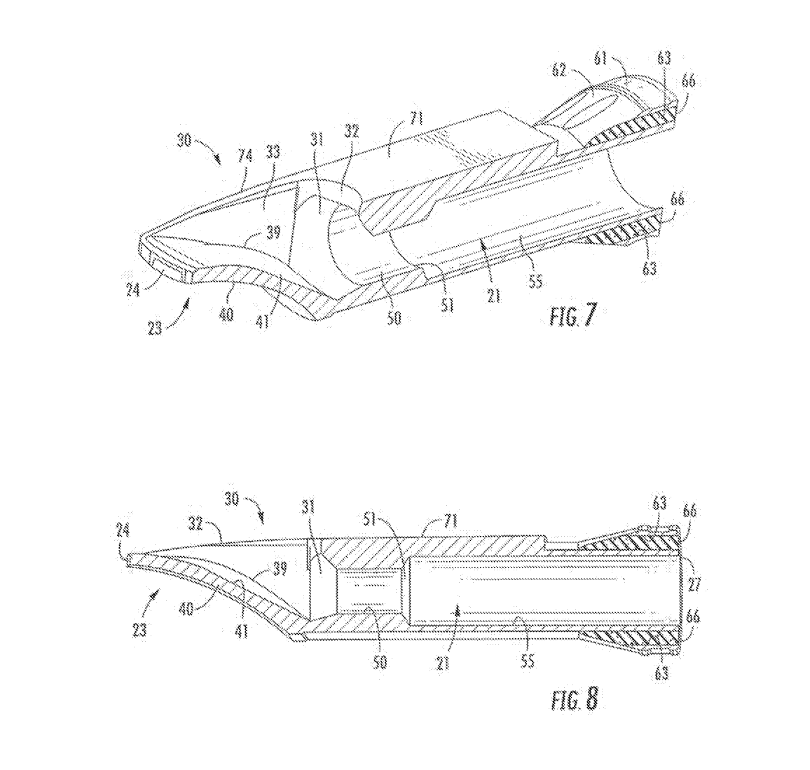

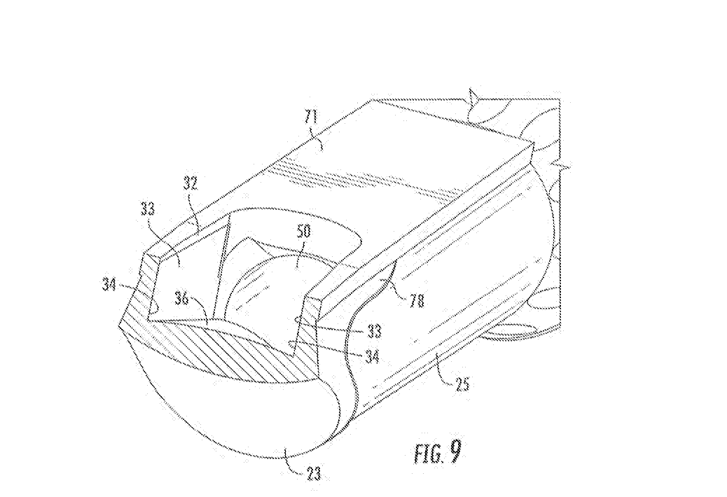

In one aspect of the mouthpiece 20, the baffle 35 has three generally parallel sections or paths that are generally parallel to the path of the airflow passage 21. More specifically, the baffle 35 has a central section 36 along a lateral centerline of the baffle 35. An outer section 38 extends between the central section 36 and each of the sidewalls 33 to define a pair of generally parallel, spaced apart outer sections 38. As best seen in FIGS. 7-9, the central section 36 and the outer sections 38 are approximately the same distance from the window 32 generally adjacent the front tip 24 of the mouthpiece 20. Moving along baffle 35 towards tone chamber 50, the central section 36 of baffle 35 is closer to the window 32 than are the outer sections 38 as depicted in FIG. 8. In other words, the distance between the central section 36 and the window 32 is less than the distance between the outer sections 38 and the window at generally equal distances along a path through the airflow passage 21. The central section 36 and the outer sections 38 then generally converge and are approximately the same distance from the window at the rear end 31 of forward section 30. As such, the baffle 35 is generally stepped or has a hump laterally relative to mouthpiece 20 to define a first high path that is closer to window 32 and a pair of second low paths that are farther from window 32.

Comparing FIGS. 5-6 to FIGS. 7-8, it may be seen that center portion 39 of the outer wall 40 adjacent the central section 36 of baffle 35 is thicker than the outer portions 41 of the outer wall 40 adjacent the outer sections 38 of baffle 35. Still further, it may be seen that the central section 36 of baffle 35 has a smaller radius than the outer sections 38 of baffle 35. As such, baffle 35 has a central section 36 that is portion of a high baffle and assists in producing relatively bright tones. The outer sections 38 of baffle 35 are a portion of a low baffle and thus assist in producing relatively dark tones. The performance characteristics of the mouthpiece 20 may be adjusted by controlling the dimensions and relationships between the central section 36 and the outer sections 38 as well as the positioning of the window 32 and sidewalls 33.

The baffle 35 may also be characterized as defining three generally parallel paths through the forward section 30 of airflow passage 21. A central path 42 is aligned with the central section 36 and an outer path 43 is aligned with each of the outer sections 38 to define a pair of spaced apart, generally parallel outer paths. By adjusting the width and the radius of the central section 36 and the thickness of the center portion 39 of outer wall 40 relative to the outer portions 41 of outer wall 40, the brightness or darkness of the mouthpiece 20 may be enhanced or adjusted as desired. It is believed that providing a first brighter path along central path 42 and at least one darker path along outer paths 42 will allow a player to realize the benefits of both a brighter mouthpiece and a darker mouthpiece, all within the same mouthpiece.

In some mouthpieces, the main body or barrel 25 may be generally thin and the mouthpiece may be viewed as being brighter or harsher than desired. In another aspect of the depicted mouthpiece 20, an enlarged rear section or tenon 26 may be provided to dampen or darken the tone of the mouthpiece. The enlarged rear section 26 may be provided adjacent rear edge 27 and may be integrally formed with the mouthpiece 20. The rear section 26 is believed to capture additional vibrations to enhance the sound characteristics of the mouthpiece 20. The rear section 26 may have a generally cylindrical portion 61 and a tapered portion 62 that extends from the outer surface 28 of main body 25 to the cylindrical portion 61. As such, tapered portion 62 may be a generally semi-frusto conical shape.

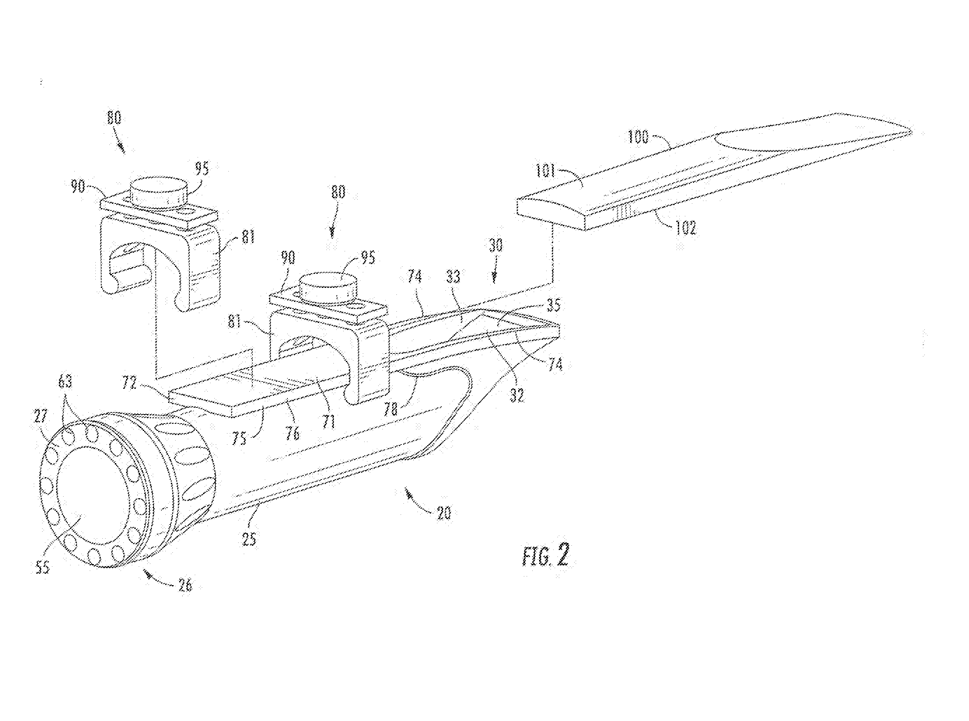

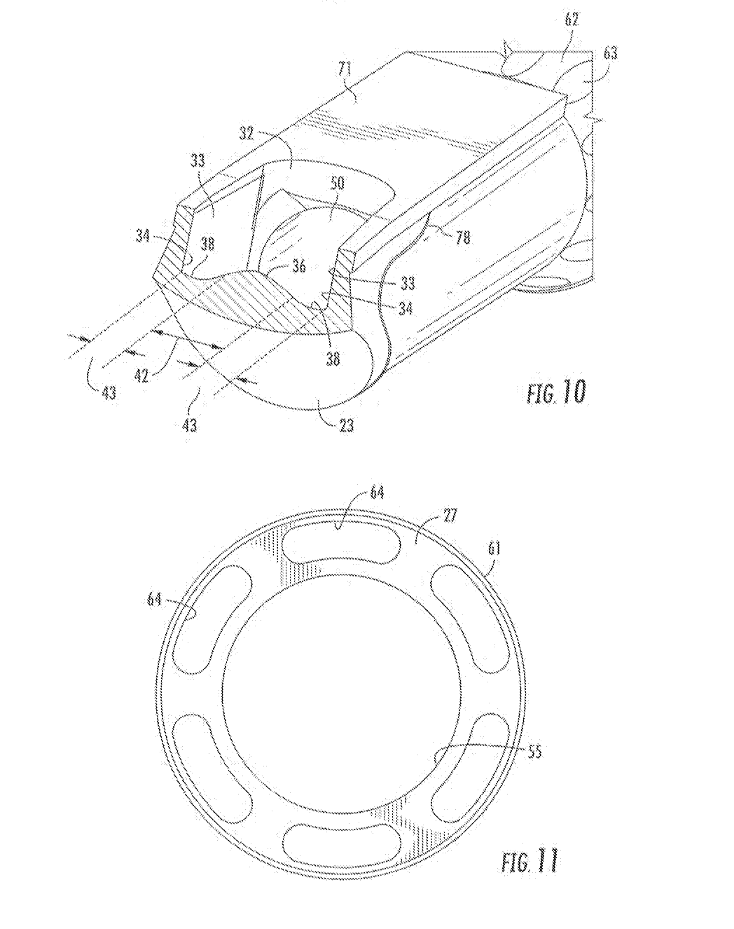

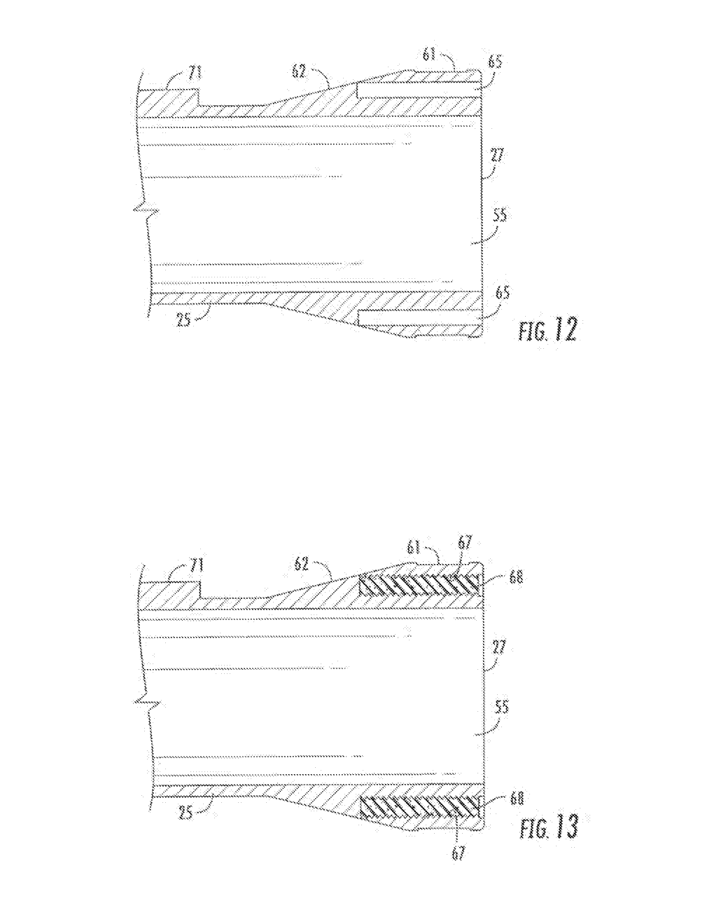

The sound characteristics of the rear section 26 may be varied by changing the size or diameter of the cylindrical portion 61 and the tapered portion 62. In addition, the sound characteristics may be further varied by providing openings or bores in the rear section 26. In one example depicted in FIGS. 5-8, cylindrical bores 63 may extend through the cylindrical portion 61 and the tapered portion 62. In other embodiments, the openings may be configured as arcuate slots 64 (FIG. 11) and/or may be holes 65 (FIG. 12) that do not extend all of the way through the cylindrical portion 61 and the tapered portion 62. As best seen in FIG. 2, the bores 63 may be positioned along a generally circular path around the rear bore 55 of the mouthpiece 20.

In order to further enhance or adjust the tone of the mouthpiece 20, the openings or bores 63 may have material therein that is different from the material from which the mouthpiece 20 is formed. For example, if mouthpiece 20 is formed of brass, the bores 63 may have an epoxy 66 or other filler material therein having characteristics different from the mouthpiece 20. In still other embodiments, the bores 63 may be filled with a metal material such as copper or stainless steel. Still further, the bores 63 may be filled with a plastic material. The material may be press fit into the bores 63 and held in place with an interference fit or held in place with an adhesive such as epoxy. In still another embodiment, the bores 67 may be threaded and the material 68 to be inserted may be formed with similarly shaped threads and the additional material screwed into the bores.

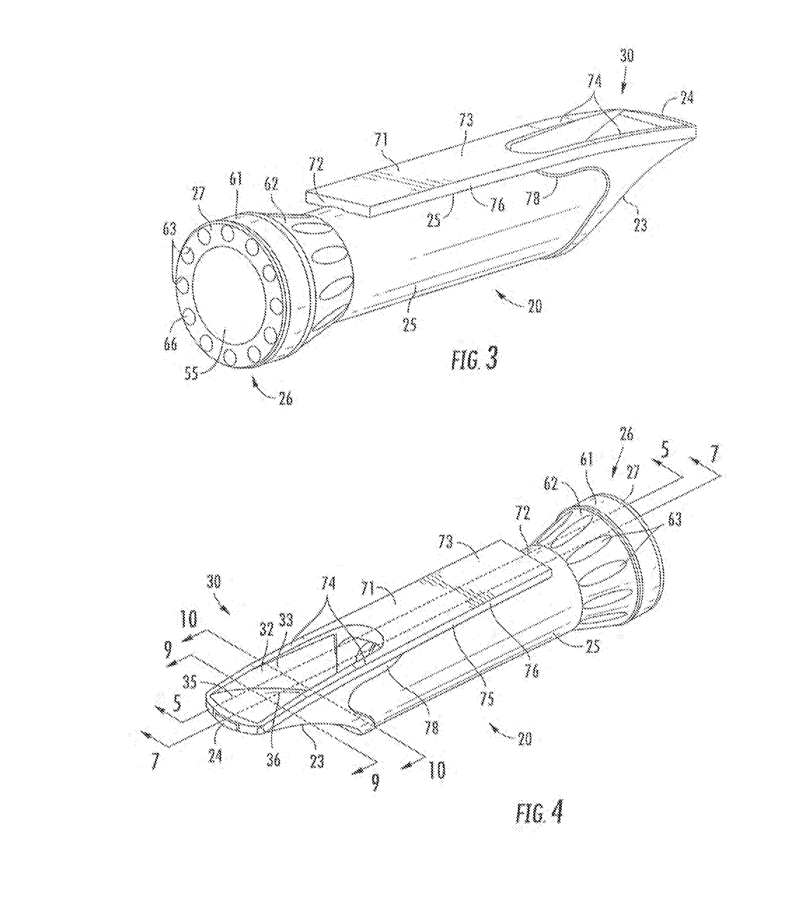

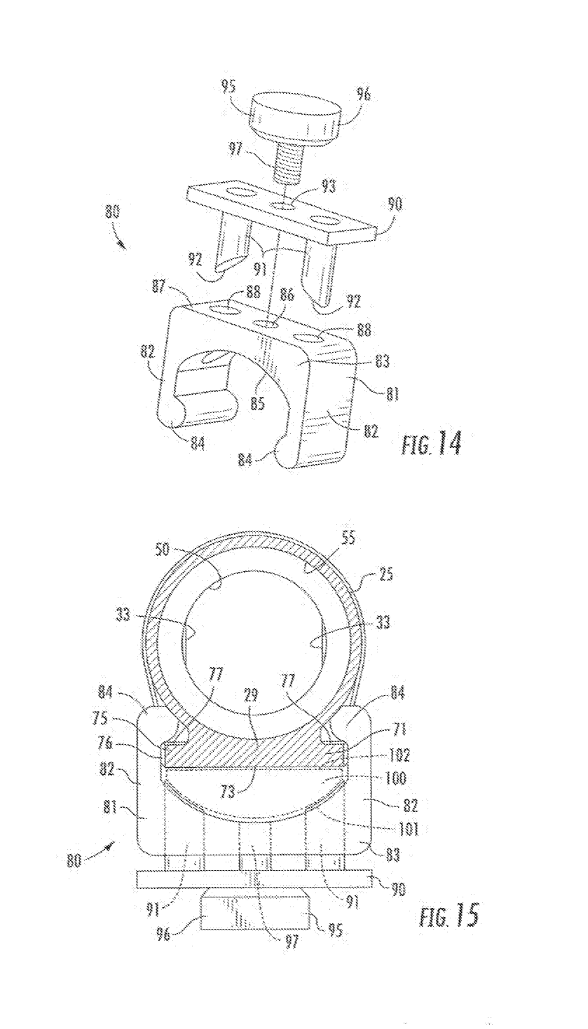

Referring to FIGS. 2-4, mouthpiece 20 has a generally planar table 71 with a lower surface 73 upon which the reed 100 is positioned. Side rails 74 extend forward from opposite sides of table 71 and extend forwardly around window 32. Table 71 is wider than the main body 25 at the lower edge 29 (FIG. 15) of the main body so as to create a pair of outwardly extending generally parallel rails 75. In other words, the rails 75 are an extension of the table 71 and interact with ligatures 80 to secure reed 100 to the table. If desired, the rails 75 may be spaced vertically from the table 71 so as not to be aligned with the table. Each rail 75 has a side edge 76 and an upwardly facing engagement surface 77. A stop in the form of a projection or ramp 78 may be provided along the upwardly facing engagement surface 77 at the forward end of each rail 75.

A pair of ligatures 80 may be provided for clamping or securing the reed 100 to the table 71. Referring to FIG. 14, one embodiment of a ligature is depicted. Ligatures having other configurations are contemplated. In addition, structures other than rails 75 are contemplated for securing a ligature to the mouthpiece. However, one aspect of the disclosure contemplates a pair of ligatures, regardless of the structure, that are independently movable about mouthpiece 20 for mounting reed 100 to the mouthpiece

Each ligature 80 has a generally U-shaped main body 81, a moveable plate 90 and a thumb screw 95. The components (main body 81, moveable plate 90 and thumb screw 95) of the ligature 80 may be formed of any suitable material including metal such as brass or stainless steel. Main body 81 has a pair of spaced apart legs 82 and a central connecting section or bright 83 connecting the spaced apart legs 82. Legs 82 have enlarged rail engagement sections or fingers 84 for engaging the upwardly facing engagement surface 77 of the rails 75. Connecting section 83 may have a generally arcuate inner surface 85 for positioning adjacent the reed 100. A threaded central bore 86 may extend between the arcuate inner surface 85 and the lower surface 87 at the center of connecting section 83. A pair of outer bores 88, each on opposite sides of central bore 86, extend between the arcuate inner surface 85 and the lower surface 87 of connecting section 83.

A pair of reed engagement posts or members 91 extend upwardly (as viewed in FIG. 15) from moveable plate 90. The upper ends 92 of the reed engagement posts 91 are configured to engage the lower or ligature engaging surface 101 of the reed 100. In the depicted embodiment, the lower surface 101 of the reed 100 has a generally arcuate shape and thus the upper ends 92 of the reed engagement posts 91 are somewhat arcuate and at an angle so that generally the entire surface of the upper ends 92 of the reed engagement posts 91 engage the lower surface 101 of the reed 100. This configuration distributes the forces applied through the ligature 80 by reducing the likelihood of any point concentration of the reed clamping forces.

The reed engagement posts 91 may be fixed to moveable plate 90 in any appropriate manner. For example, screws (not shown) may extend through moveable plate 90 and into threaded holes (not shown) in reed engagement posts 91. In another alternative, the reed engagement posts 91 may have threaded ends (not shown) that are threaded into the moveable plate 90. The reed engagement posts 91 are dimensioned so as to be slidable through outer bores 88 in the main body 81 of ligature 80.

Moveable plate 90 has a central bore 93 positioned between reed engagement posts 91. A threaded thumb screw 95 has an enlarged head 96 for manual manipulation and a threaded shaft 97 for operative engagement with threaded central bore 86 of main body 81 of ligature 80. Central bore 93 is dimensioned so that the threaded shaft 97 of thumb screw 95 may pass through the central bore 93 without interference. Upon rotating the thumb screw 95 to raise the thumb screw relative to the main body 81, the upper surface 98 of the head 96 of the thumb screw will engage the lower surface 94 of the connecting plate 90 and force the connecting plate upward. Movement of the connecting plate 90 upward causes the reed engagement pins 91 to move upward and into contact with the lower surface 101 of reed 100 to secure the reed in place against table 71. Continued rotation of thumb screw 95 will force the rail engagement sections 84 on the legs 82 of the ligature 80 against the upwardly facing engagement surface 77 of each rail 75. Friction between the threads of the shaft 97 of the thumb screw 95 and the central bore 86 of the main body 81 will secure the ligature 80 in place against mouthpiece 20.

During assembly of a ligature 80, movable plate 90 is positioned so that the reed engagement posts 91 extend through the outer bores 88 of the connecting section 83 of main body 81. The thumb screw 95 is then inserted through the central bore 93 in the movable plate 90 and threaded into threaded central bore 86 of the connecting section 83.

When mounting a reed 100 on mouthpiece 20, the mouthpiece is typically oriented upside down as depicted in FIG. 2. The flat or upper surface 102 of the reed 100 is placed against the table 71 of the mouthpiece with the reed positioned longitudinally relative to the mouthpiece as desired. A first or forward ligature 80a is positioned adjacent a rear edge 72 of table 71 adjacent the rear section 26 with the legs 82 of the ligature positioned on opposite sides of the rails 75 and the rail engagement sections 84 of the legs 82 positioned below (as depicted in FIG. 2) the upwardly facing engagement surface 77 of the rails. The forward ligature 80a is then slid forwards toward the front tip 24 of the mouthpiece 20 to a desired position while maintaining the reed 100 in place. The forward ligature 80a may then be tightened as desired to secure the reed 100. The process is then repeated for the second or rear ligature 80b so that two ligatures 80 may be mounted on the mouthpiece 20.

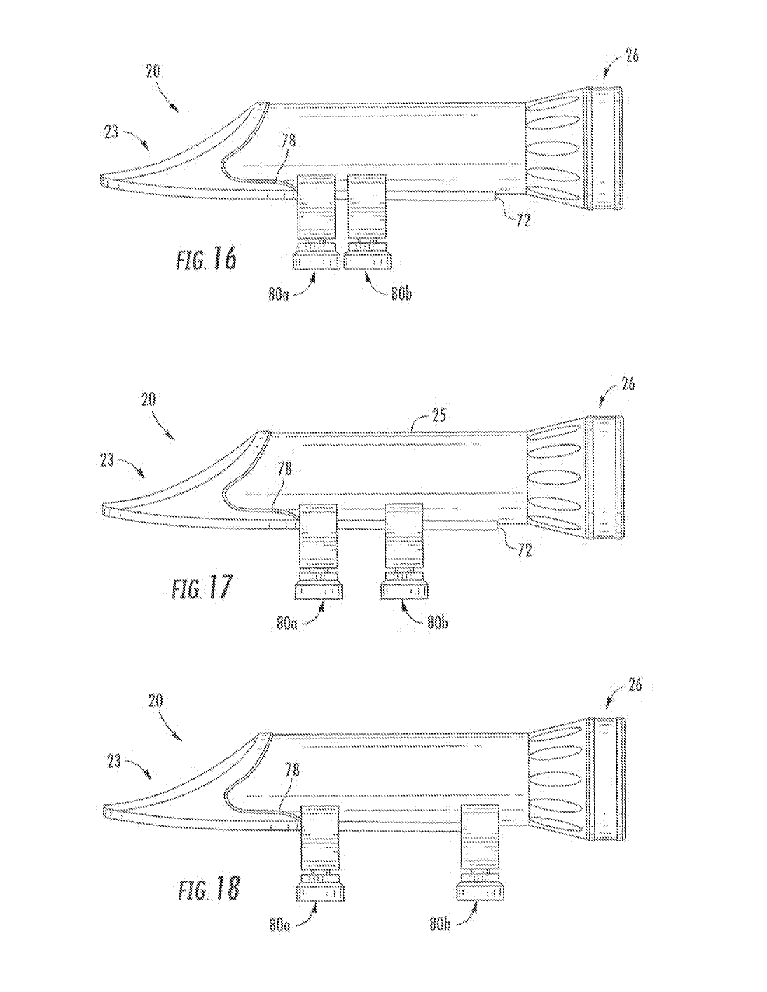

Due to the configuration of the rails 75 and the ligatures 80, the ligatures are independently moveable along the rails to create a significant amount of flexibility in ligature placement. More specifically, the forward ligature 80a may be moved forward until it reaches the ramp 78. The rear ligature 80b may be moved as far back as the rear edge or end 72 of table 71. Referring to FIGS. 16-20, it may be seen that the ligatures 80 are independently moveable and thus permit the reed 100 to be secured or engaged at many different positions. It should be noted that the ligatures 80 are relatively narrow in a longitudinal direction relative to the mouthpiece 20 so as to maximize the number different positions at which the ligatures may be located. For example, with a mouthpiece having a length of approximately 4¼ inches and a distance between the rear edge 72 of table 71 and the ramp 78 of approximately 1½ inches, the ligatures may have a depth of approximately ¼ inch relative to a longitudinal axis of the mouthpiece 20. In another configuration, the ligatures 80 may have a depth of between approximately ¼ inch and ⅜ inch along the longitudinal axis of the mouthpiece. In another example, a mouthpiece 20 may only be approximately 2½ in length in which case smaller ligatures are likely to be especially desirable.

The manner in which the reed 100 is secured to the mouthpiece 100 may have a significant impact on the tone generated by the mouthpiece. The position of the reed 100 relative to the table 71 as well as the force used to secure the reed will both affect the generated tone. In addition, the position of the ligatures 80 will affect the generated tone. By adjusting the position of the forward ligature 80a and the rear ligature 80b relative to table 71, the tone generated by the mouthpiece 20 may be adjusted. The two ligatures will also hold the reed in place with two areas of engagement against table 71. In some situations, it may be desirable to hold the reed 100 relatively loosely against table 71. In such case, the second ligature may permit a musician to secure the reed 100 in place with less concern that it will loosen during use of the musical instrument.

FIGS. 16-20 depict examples of some of the many possible different ligature configurations that may be used with the mouthpiece 20. In such figures, the reed 100 is not depicted. In a first example, FIG. 16 depicts a mouthpiece 20 with the forward ligature 80a adjacent the ramp 78 and the rear ligature 80b adjacent the forward ligature. It is believed that such a configuration will secure the reed 100 so as to have a relatively short vibrating forward section, which will then create a relatively high pitched tone. The portion of the reed 100 rearward of the rear ligature 80b may affect the generated tones.

FIG. 17 depicts an alternate reed securing configuration with the forward ligature 80a adjacent the ramp 78 and the rear ligature approximately at the midpoint of table 71. It is believed that this configuration will produce a relatively short initial vibrating portion of the reed 100 and permit some additional vibration of the reed between the forward ligature 80a and the rear ligature 80b. In addition, the portion of the reed 100 rearward of the rear ligature 80b may further affect the generated tones.

FIG. 18 depicts another alternate reed securing configuration with the ligatures 80 spaced apart by a maximum amount. The forward ligature 80a is positioned adjacent the ramp 78 and the rear ligature 80b is positioned adjacent the rear edge 72 of table 71. It is believed that the forward ligature 80a will secure the front portion of the reed 100 so as to create a relatively short vibrating forward section and thus a relatively high pitched tone. By engaging the rear portion of the reed 100 adjacent the rear edge 72 of table 71 with the rear ligature 80b, additional vibration of the reed may occur between the forward ligature 80a and the rear ligature 80b.

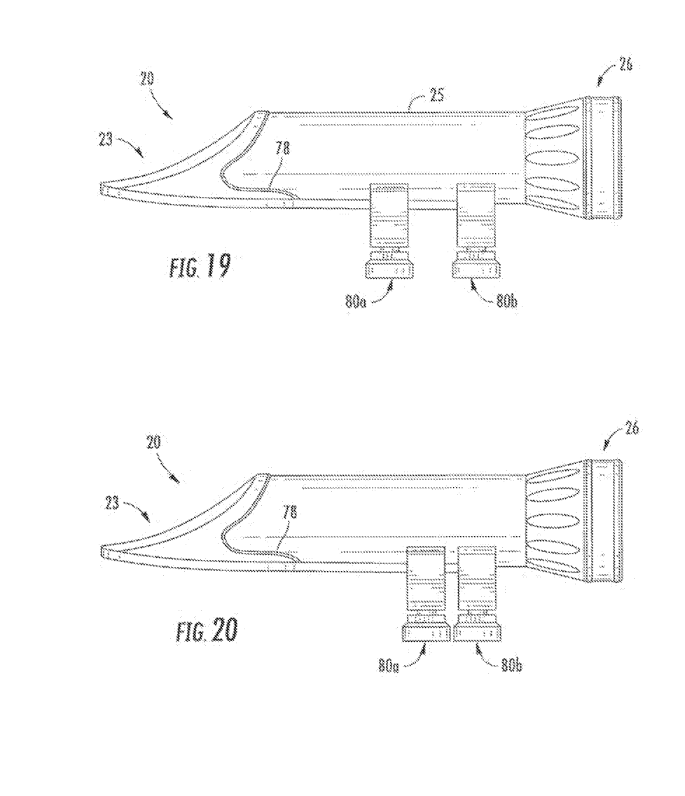

FIG. 19 depicts still another alternate reed securing configuration with the rear ligature 80b adjacent the rear edge 72 of table 71 and the forward ligature 80a positioned at approximately the midpoint of the table 71. This configuration will constrain the reed 100 generally adjacent the midpoint of the table 71 to mid-length initial vibrating portion of the reed and may permit some additional vibration of the reed between the forward ligature 80a and the rear ligature 80b.

FIG. 20 depicts another alternate reed securing configuration with the rear ligature 80b at its rear most position adjacent the rear edge 72 of table 71 and the forward ligature 80a adjacent the rear ligature. Such configuration will secure the reed 100 with a relatively long vibrating section and thus produce a relatively lower pitched tone.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context. For example, the present disclosure describes an enlarged rear section or tenon, a baffle, and independently moveable ligatures. Each of these features may be implemented individually or in combination with any or all of the other features.

1. A mouthpiece for a woodwind musical instrument comprising:
a generally tapered front end;
a rear end configured for mounting to the musical instrument;
a generally cylindrical body between the front end and the rear end;
an elongated airflow passage extending along a path between the front end and the rear end, a window defining an opening of the passage generally adjacent the front end;
the body including a table upon which a reed may be mounted such that a mounted reed extends generally across at least a portion of the window; and
the rear end having an enlarged generally cylindrical tenon section integrally formed therewith, the tenon section being larger than the cylindrical body.

2. The mouthpiece for a woodwind musical instrument of claim 1, wherein the body has a first diameter, the tenon section has a second diameter, and the second diameter is greater than the first diameter.

3. The mouthpiece for a woodwind musical instrument of claim 1, wherein the tenon section includes a generally cylindrical section and a tapered section extending between the cylindrical body and the generally cylindrical section of the tenon section.

4. The mouthpiece for a woodwind musical instrument of claim 3, wherein the tapered section is generally semi-frusto conically shaped.

5. The mouthpiece for a woodwind musical instrument of claim 1, wherein the tenon section has a plurality of openings therein.

6. The mouthpiece for a woodwind musical instrument of claim 5, wherein the plurality of openings are uniformly spaced about the tenon section.

7. The mouthpiece for a woodwind musical instrument of claim 5, wherein the mouthpiece is formed of a first material and the openings have a second material therein.

8. The mouthpiece for a woodwind musical instrument of claim 1, wherein the tenon section has a plurality of bores therein, each bore having an axis extending generally parallel to an axis of the airflow passage.

9. The mouthpiece for a woodwind musical instrument of claim 8, wherein the bores are positioned generally along a circular path around the airflow passage.

10. The mouthpiece for a woodwind musical instrument of claim 8, wherein the bores extend through the tenon section.

11. The mouthpiece for a woodwind musical instrument of claim 8, wherein the mouthpiece is formed of a first material and the bores have a second material therein.

12. A mouthpiece for a woodwind musical instrument comprising:
a generally tapered front end;
a rear end configured for mounting to the musical instrument;
a generally cylindrical body between the front end and the rear end, the generally cylindrical body having a first body diameter;
an elongated central airflow passage extending along a path between the front end and the rear end, the central airflow passage having a forward section and an adjacent tone chamber;
the body including a table configured for mounting a reed thereon such that a mounted reed extends across at least a portion of the passage; and
the rear end having an enlarged generally cylindrical tenon section, the tenon section having a second tenon diameter larger than the first body diameter, the tenon section further including a plurality of openings therein.

13. The mouthpiece for a woodwind musical instrument of claim 12, wherein the mouthpiece is formed of a first material and the openings have a second material therein.

14. The mouthpiece for a woodwind musical instrument of claim 12, wherein the plurality of openings in the tenon section are a plurality of bores, each bore having an axis extending generally parallel to an axis of the central airflow passage.

15. The mouthpiece for a woodwind musical instrument of claim 14, wherein the bores are positioned generally uniformly spaced along a circular path around the central airflow passage.

16. The mouthpiece for a woodwind musical instrument of claim 14, wherein the bores extend through the tenon section.

17. A mouthpiece for a woodwind musical instrument comprising:
a front end;
a rear end configured for mounting to the musical instrument;
a generally cylindrical body between the front end and the rear end, the generally cylindrical body having a first body diameter;
an elongated airflow passage extending along a path between the front end and the rear end, the airflow passage having a forward section and an adjacent tone chamber;
the body including a table configured for mounting a reed thereon such that a mounted reed extends across at least a portion of the airflow passage; and
the rear end having an enlarged tenon section, the tenon section having a generally cylindrical section and a tapered section extending between the cylindrical body and the generally cylindrical section of the tenon section, the generally cylindrical section of the tenon section having a second tenon diameter larger than the first body diameter.

18. The mouthpiece for a woodwind musical instrument of claim 17, wherein the tapered section is generally semi-frusto conically shaped.

19. The mouthpiece for a woodwind musical instrument of claim 17, wherein the tenon section further includes a plurality of openings therein uniformly spaced about the tenon section.

20. The mouthpiece for a woodwind musical instrument of claim 18, wherein the plurality of openings in the tenon section are a plurality of bores, each bore having an axis extending generally parallel to an axis of the airflow passage.
